(19) United States
(12) Patent Application Publication
(10) Pub. No.: US 2021/0157618 A1
(43) Pub. Date: May 27, 2021

(54) System and Method for Executing an Action in an Application Using Information Associated with a Chat User Interface

(71) Applicant: The Toronto-Dominion Bank, Toronto (CA)

(72) Inventor: Tae Gyun MOON, Toronto (CA)

(21) Appl. No.: 16/696,655

(22) Filed: Nov. 26, 2019

(51) Int. Cl. G06F 9/451; H04L 12/58; G06F 17/24; G06Q 40/02

(52) U.S. Cl. CPC G06F 9/453; G06Q 40/02; G06F 17/243; H04L 51/02

(57) ABSTRACT

A system and method are provided for identifying and executing actions from chat user interfaces. The method is executed by a device having a communications module. The method includes determining an intention to execute an action, from information in a chat conversation between a client device and an entity in a chat user interface. The method also includes accessing, via the communications module, at least one element of client information required to execute the action, the at least one element of client information being accessible by the device using authenticated access to a database of client information. The method also includes pre-populating at least one field required to execute the action using the at least one element of client information, and enabling the action to be executed.

### TECHNICAL FIELD

The following relates generally to executing actions in applications using information associated with a chat user interface.

### BACKGROUND

Organizations may provide an instant messaging or “chat” function within a website or application to allow a customer or client to ask questions and receive responses in a conversational style exchange. These chat functions typically include live agents from the organization or an automated conversational agent, commonly referred to as a “chatbot”.

Chatbots are becoming popular as their autonomy and intelligence improves. Chatbots can be developed and deployed as to enable a user of an application (e.g., a customer) to ask questions and receive answers, typically for routine inquires or to determine when an issue might be more complex and thus a live agent is necessary.

For example, a user may ask a chatbot how to perform a task or execute an action within a website or mobile application of an organization. While the chatbot may be able to provide some assistance with identifying what the user can do, the user may still need to navigate to the application to perform the task or action and may be faced with doing so without further assistance from the chatbot.

### BRIEF DESCRIPTION OF THE DRAWINGS

Embodiments will now be described with reference to the appended drawings wherein:

FIG. 1 is a schematic diagram of an example computing environment.

FIG. 2 is a block diagram of an example configuration of a chat platform.

FIG. 3 is a block diagram of an example configuration of a financial institution system.

FIG. 4 is a block diagram of an example configuration of a client computing device associated with a user, customer, or client.

FIG. 5 is a flow diagram of an example of computer executable instructions for executing actions in applications using information determined from a chat user interface.

FIG. 6 is an example of a graphical user interface for of a chat application.

FIG. 7 is an example of a graphical user interface of an application form with pre-populated elements.

FIG. 8 is an example of a graphical user interface of a chat application showing an example conversation with a chatbot.

FIG. 9 is an example of a graphical user interface of an application form with pre-populated elements for arranging a transfer of funds from one account to another.

FIG. 10 is a flow diagram of an example of computer executable instructions for executing an action in an application by navigating to that application.

FIG. 11 is an example of a graphical user interface of a chat application with a proposed action displayed within a chat message.

FIG. 12 is an enlarged view of an example of a chat message showing a form with pre-populated elements for arranging a transfer of funds from one account to another.

FIG. 13 is a flow diagram of an example of computer executable instructions for executing an action within a chat user interface.

FIG. 14 is a flow diagram of an example of computer executable instructions for predicting an action from a conversation in a chat user interface.

FIG. 15 is an example of a graphical user interface of a chat application showing a predicted action determined from an example conversation.

FIG. 16 is an example of a graphical user interface of a form with pre-populated elements for arranging a transfer of funds from one account to another based on the predicted action shown in FIG. 15.

FIG. 17 is an example of a graphical user interface of the chat application shown in FIG. 15 after navigating back from the form shown in FIG. 16.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Currently, chatbots used by organizations to answer questions posed by customers or clients may be able to arrive at a suitable answer and can suggest which part of the website or application is appropriate. However, this often still requires that the user navigate to that portion and be faced with entering information, selecting settings, etc. Moreover, the user may be faced with doing so without further assistance from the chatbot.

A platform is provided that includes a “smart” chatbot configured to use a combination of contextual information determined from an exchange of messages between the chatbot and the user and authenticated access to user information (e.g., financial/account information), to determine what action the user desires, and to pre-populate or pre-execute at least some of what is required for that action in an associated user interface, such as that in a mobile application or web browser. For example, the user may use a conversation with a chatbot to determine how to transfer funds from a chequing account to a savings account, and to determine how much they can transfer at that time or in the future (e.g., due to balance, transfer restrictions, etc.). The chatbot described herein can use this contextual information and access to financial data for the user to provide a link to a “transfer funds” form in a related banking application, directly from a message. In this example scenario, the user can select the link and navigate directly to the transfer form with certain fields pre-populated based on the user information that was obtained by the chat platform or chatbot. In this example, the fields could include fields such as originating account, destination account, date, amount, and frequency of transfer.

In certain example embodiments, the action can be presented and executed from directly within the chat user interface, e.g., by presenting fields within a chat message and confirming same without the need to navigate to the related application.

In other example embodiments, predictions can be made by the chatbot to suggest an action based on previous activities and/or the context of a conversational exchange between the chatbot and the user. That is, the chatbot may be configured to not only determine the pre-populated information but also to predict the action to be taken, to further minimize the interactions required by the user. For example, the chatbot could predict that the user may want to do a monthly transfer to a savings account and pre-emptively suggest this in a chat message.

Certain example systems and methods described herein are able to identify and execute actions based on information and interactions obtained from messages exchanged within a chat user interface. In one aspect, there is provided a device for identifying and executing actions from chat user interfaces. The device includes a processor, a communications module coupled to the processor, and a memory coupled to the processor. The memory stores computer executable instructions that when executed by the processor cause the processor to determine an intention to execute an action, from information in a chat conversation between a client device and an entity in a chat user interface. The memory also stores computer executable instructions that when executed by the processor cause the processor to access via the communications module at least one element of client information required to execute the action, the at least one element of client information being accessible by the device using authenticated access to a database of client information. The memory also stores computer executable instructions to pre-populate at least one field required to execute the action with the at least one element of client information and to enable the action to be executed.

In another aspect, there is provided a method of identifying and executing actions from chat user interfaces. The method is executed by a device having a communications module. The method includes determining an intention to execute an action, from information in a chat conversation between a client device and an entity in a chat user interface. The method also includes accessing, via the communications module, at least one element of client information required to execute the action, the at least one element of client information being accessible by the device using authenticated access to a database of client information. The method also includes pre-populating at least one field required to execute the action with the at least one element of client information and enabling the action to be executed.

In another aspect, there is provided non-transitory computer readable medium for identifying and executing actions from chat user interfaces. The computer readable medium includes computer executable instructions for determining an intention to execute an action, from information in a chat conversation between a client device and an entity in a chat user interface. The computer readable medium also includes computer executable instructions for accessing, via the communications module, at least one element of client information required to execute the action, the at least one element of client information being accessible by the device using authenticated access to a database of client information. The computer readable medium also includes computer executable instructions for pre-populating at least one field required to execute the action with the at least one element of client information and enabling the action to be executed.

In certain example embodiments, an application for executing the action can be displayed via the client device. The application can include a plurality of fields required to execute the action, including the at least one pre-populated field. Navigation back to the chat user interface can be enabled after executing the action and the chat user interface and application can be displayed side-by-side on a display of the client device.

In certain example embodiments, a plurality of fields required to execute the action can be displayed by the client device, including the at least one pre-populated field, with a message in the chat user interface.

In certain example embodiments, the action is associated with a financial transaction requiring a form to be populated.

In certain example embodiments, the intention to execute the action can be determined from at least one question added to the conversation by the client device.

In certain example embodiments, the intention to execute the action can be predicted based on content from at least one message in the conversation. The device can further suggest a predicted action and have the client device confirm the predicted action.

In certain example embodiments, a periodic action to be executed on a periodic basis subsequent to the action being executed can be suggested, the client device can confirm the periodic action, and the periodic action can be arranged for an application used by the client device.

In certain example embodiments, an incompatible one of a plurality of elements of client information can be determined, an incompatibility in a corresponding pre-populated field can be indicated, and it can be determined that the incompatibility has been rectified prior to enabling the action to be executed. The incompatibility can be indicative of a value that is incompatible with the action to be executed. The value can be associated with a financial transaction.

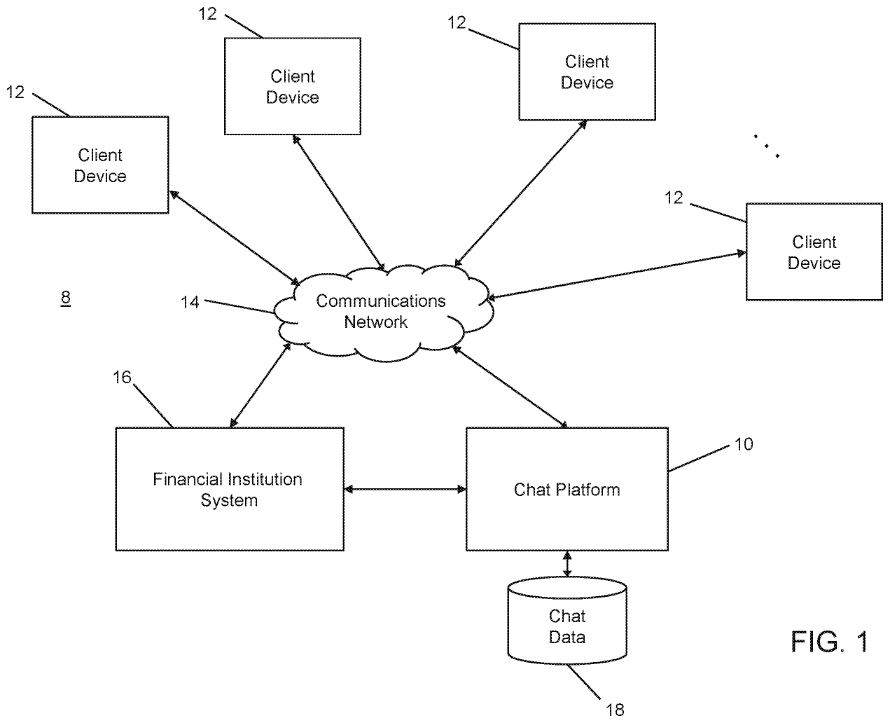

FIG. 1 illustrates an exemplary computing environment 8. In one aspect, the computing environment 8 may include a chat platform 10 (referred to interchangeably as “the platform 10” herein), one or more client devices 12, and a communications network 14 connecting one or more components of the computing environment 8.

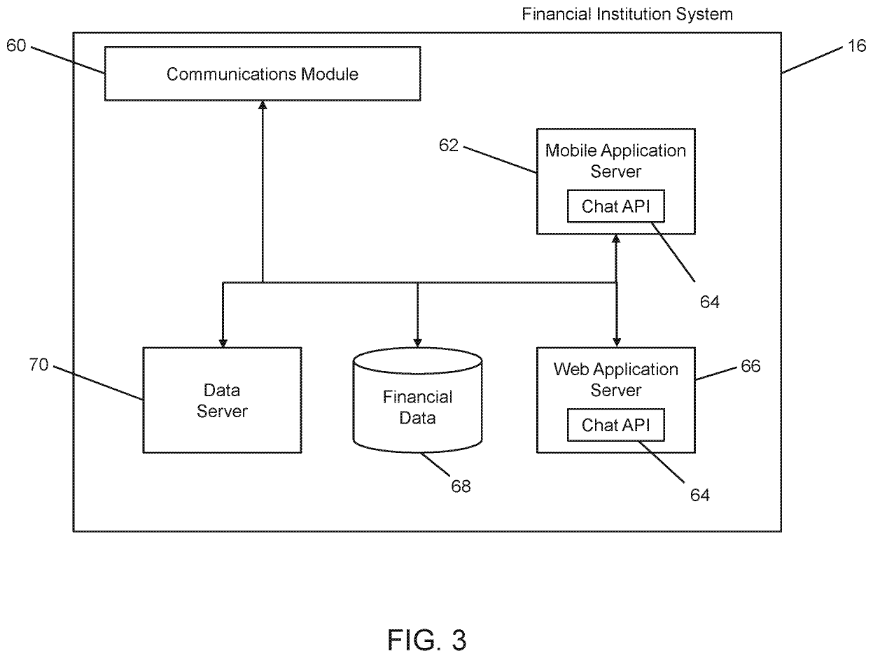

The computing environment 8 may also include a financial institution system 16 (e.g., a commercial bank) that provides financial services accounts to users and processes financial transactions associated with those financial service accounts. While several details of the financial institution system 16 have been omitted for clarity of illustration, reference will be made to FIG. 3 below for additional details.

The chat platform 10 includes or otherwise has access to a datastore for storing chat data 18. The chat data 18 may include both data associated with a user of a client device 12 that interacts with the chat platform 10 (e.g., for participating in conversational exchanges of messages with an agent or bot of the chat platform 10) and conversation history data, such as messages, attachments, and other content associated with chats associated with the respective user. The data associated with a user can include client profile data that may be mapped to corresponding financial data 68 (see FIG. 3) for that user and/or may include some of the financial data 68. The client profile data can include both data that is associated with a client as well as data that is associated with one or more user accounts for that client as recognized by the platform 10. The data associated with a client may include, without limitation, demographic data (e.g., age, gender, income, location, etc.), preference data input by the client, and inferred data generated through machine learning, modeling, pattern matching, or other automated techniques. The client profile data may also include historical interactions and transactions associated with the chat platform 10, e.g., login history, search history, communication logs, document sharing metrics, etc. The client profile data may also include documents, media content or other files that are being shared on the platform 10 via a chat or other user interface, or otherwise stored for the client.

It can be appreciated that the datastore for the chat data 18 is shown separately from the platform 10 for illustrative purposes only and may also be at least partially stored within a database, memory, or portion thereof within the chat platform 10. It can also be appreciated that while the chat platform 10 and financial institution system 16 are shown as separate entities in FIG. 1, they may also be part of the same system. For example, the platform 10 can be hosted and provided within the financial institution system 16.

Client devices 12 may be associated with one or more users. Users may be referred to herein as customers, clients, correspondents, or other entities associated with an exchange of data and messages via a chat user interface. The computing environment 8 may include multiple client devices 12, each client device 12 being associated with a separate user or associated with one or more users. In certain embodiments, a user may operate client device 12 such that client device 12 performs one or more processes consistent with the disclosed embodiments. For example, the user may use client device 12 to engage and interface with a chatbot or live agent via the chat platform 10 to assist in conducting a task or otherwise executing an “action”. It can be appreciated that the principles discussed herein with respect to using a chatbot can equally apply to a live agent utilizing a “smart” chat user interface. The chat platform 10 may be used and/or provided by another system, in this example the financial institution system 16, to enable users to ask questions or otherwise determine information about accounts, products, services, technical difficulties, etc. In certain aspects, client device 12 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of client devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

In one embodiment, platform 10 may be one or more computer systems configured to process and store information and execute software instructions to perform one or more processes consistent with the disclosed embodiments. In certain embodiments, although not required, platform 10 may be associated with one or more business entities. In certain embodiments, platform 10 may represent or be part of any type of business entity. For example, platform 10 may be a system associated with a commercial bank (e.g., financial institution system 16), a retailer, or some other type of business. The platform 10 can also be considered a standalone entity that is configured to serve multiple business entities, e.g., to act as an agent therefor.

Referring back to FIG. 1, the platform 10 and/or financial institution system 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the platform 10 and financial institution system 16. The cryptographic server may be used to protect the financial data 68 and/or chat data 18 by way of encryption for data protection, digital signatures or message digests for data integrity, and by using digital certificates to authenticate the identity of the users and client devices 12 with which the platform 10 communicates to inhibit data breaches by adversaries. It can be appreciated that various cryptographic mechanisms and protocols can be chosen and implemented to suit the constraints and requirements of the particular deployment of the platform 10 as is known in the art.

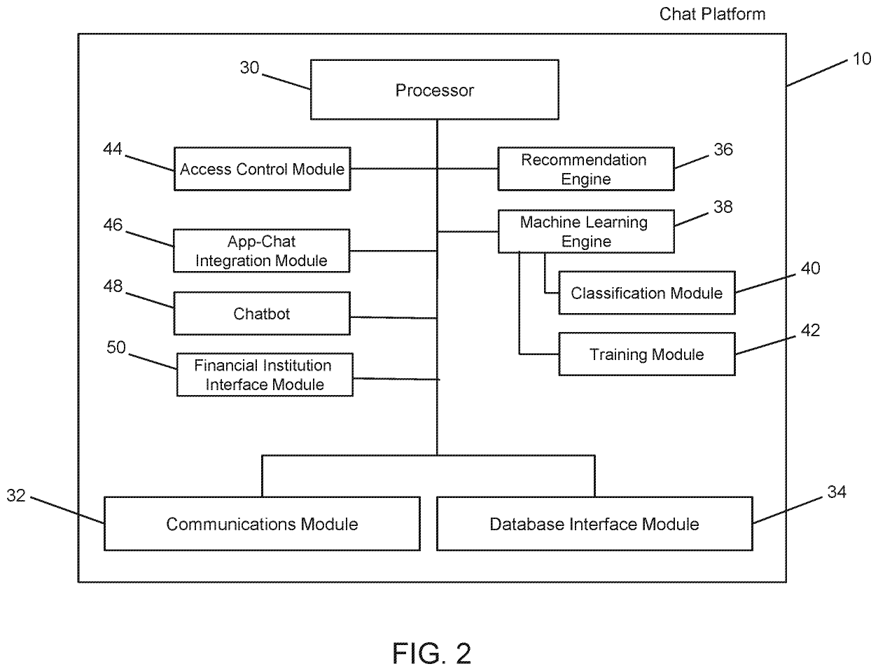

In FIG. 2, an example configuration of the chat platform 10 is shown. In certain embodiments, the platform 10 may include one or more processors 30, a communications module 32, and a database interface module 34 for interfacing with the datastore of chat data 18 to retrieve, modify, and store (e.g., add) data. Communications module 32 enables the platform 10 to communicate with one or more other components of the computing environment 8, such as client device 12 (or one of its components), via a bus or other communication network, such as the communication network 14. While not delineated in FIG. 2, the platform 10 includes at least one memory or memory device that can include a tangible and non-transitory computer-readable medium having stored therein computer programs, sets of instructions, code, or data to be executed by processor 30. FIG. 2 illustrates examples of modules, tools and engines stored in memory on the platform 10 and operated by the processor 30. It can be appreciated that any of the modules, tools, and engines shown in FIG. 2 may also be hosted externally and be available to the platform 10, e.g., via the communications module 32. In the example embodiment shown in FIG. 2, the platform 10 includes a recommendation engine 36, a machine, learning engine 38, a classification module 40, a training module 42, an access control module 44, an app-chat integration module 46, a chatbot 48, and a financial institution interface, module 50,

The recommendation engine 36 is used by the platform 10 to generate one or more recommendations for a client device 12 that is/are related to an “action” to be executed by or for the user in an area or portion of an application such as a financial institution mobile or web application. It may be noted that a recommendation as used herein may refer to a prediction, suggestion, inference, or other recommended action based on information that is provided to or inferred from the content within a chat or information related thereto. The recommendation engine 36 can access the chat data 18 and financial data 68 via the databases interface module 34 and apply one or more inference processes to generate the recommendation(s). The recommendation engine 36 may utilize or otherwise interface with the machine learning engine 38 to both classify data currently being analyzed to generate a recommendation, and to train classifiers using data that is continually being processed and accumulated by the platform 10.

The machine learning engine 38 may also perform operations that classify the chat data 18 and financial data 68 in accordance with corresponding classifications parameters, e.g., based on an application of one or more machine learning algorithms to each of the groups of data 18, 68 (also referred to herein as “user content”, “user information” or “client information”). The machine learning algorithms may include, but are not limited to, a one-dimensional, convolutional neural network model (e.g., implemented using a corresponding neural network library, such as Keras®), and the one or more machine learning algorithms may be trained against, and adaptively improved using, elements of previously classified profile content identifying suitable matches between content identified and potential actions to be executed. Subsequent to classifying the profile content, the recommendation engine 36 may further process each element of the content to identify, and extract, a value characterizing the corresponding one of the classification parameters, e.g., based on an application of one or more additional machine learning algorithms to each of the elements of the profile content. By way of example, the additional machine learning algorithms may include, but are not limited to, an adaptive natural language processing algorithm that, among other things, predicts starting and ending indices of a candidate parameter value within each element of the content, extracts the candidate parameter value in accordance with the predicted indices, and computes a confidence score for the candidate parameter value that reflects a probability that the candidate parameter value accurately represents the corresponding classification parameter. As described herein, the one or more additional machine learning algorithms may be trained against, and adaptively improved using, the locally maintained elements of previously classified content. Classification parameters may be stored and maintained using the classification module 40, and training data may be stored and maintained using the training module 42.

In some instances, classification data stored in the classification module 40 may identify one or more parameters, e.g., “classification” parameters, that facilitate a classification of corresponding elements or groups of recognized content based on any of the exemplary machine learning algorithms or processes described herein. The one or more classification parameters may correspond to parameters that can indicate an affinity or compatibility between the data 18, 68 and certain potential actions. For example, an intention of the user to transfer funds determined from a chat message, along with the existence of at least two accounts with a financial institution, can be correlated or deemed compatible or not with a fund transfer action that is normally performed within a financial institution mobile or web application.

In some instances, the additional, or alternate, machine learning algorithms may include one or more adaptive, natural-language processing algorithms capable of parsing each of the classified portions of the profile content and predicting a starting and ending index of the candidate parameter value within each of the classified portions. Examples of the adaptive, natural-language processing algorithms include, but are not limited to, natural-language processing models that leverage machine learning processes or artificial neural network processes, such as a named entity recognition model implemented using a SpaCy® library.

Examples of these adaptive, machine learning processes include, but are not limited to, one or more artificial, neural network models, such as a one-dimensional, convolutional neural network model, e.g., implemented using a corresponding neural network library, such as Keras®. In some instances, the one-dimensional, convolutional neural network model may implement one or more classifier functions or processes, such a Softmax® classifier, capable of predicting an association between an element of chat content (e.g., a value or type of desired action) and a single classification parameter (e.g., a functionality of an application) and additionally, or alternatively, multiple classification parameters (e.g., a type of account and the desired function).

Based on the output of the one or more machine learning algorithms or processes, such as the one-dimensional, convolutional neural network model described herein, machine learning engine 38 may perform operations that classify each of the discrete elements of profile content as a corresponding one of the classification parameters, e.g., as obtained from classification data stored by the classification module 40.

The outputs of the machine learning algorithms or processes may then be used by the recommendation engine 36 to find one or more requested, inferred, or predicted actions that the user may desire.

Referring again to FIG. 2, the access control module 44 may be used to apply a hierarchy of permission levels or otherwise apply predetermined criteria to determine what chat data 18 or financial data 68 can be shared with which entity in the computing environment 8. For example, the platform 10 may have been granted access to certain sensitive financial data 18 for a user, which is associated with a certain client device 12 in the computing environment 8. Similarly, certain client profile data stored in the chat data 18 or financial data 68 may include potentially sensitive information such as age, date of birth, or nationality, which may not necessarily be needed by the chat platform 10 to execute certain actions. As such, the access control module 44 can be used to control the sharing of certain client profile data or other chat data 18 and/or financial data 68 based on a type of client/user, a permission or preference, or any other restriction imposed by the computing environment 8 or application in which the chat platform 10 is used.

The platform 10 may also include an app-chat integration module 46 that is provided to enable entities in the computing environment 8 to communicate with client devices 12 via the chat platform 10, e.g., via an instant messaging or other chat-type user interface (herein referred to as a “chat user interface”). The app-chat integration module 46 can take the form of an application programming interface (API), software development kit (SDK) or any other software, plug-in, agent, or tool that allows the chat platform 10 to be integrated with or within an application associated with another entity. For example, the app-chat integration module 46 can enable chat functionality to be integrated into a financial institution application to enable users of the client devices 12 to correspond with the financial institution, e.g., as existing or prospective customers/clients.

The platform 10 may also include a chatbot 48 to enable client devices 12 to communicate with an automated agent. The chatbot 48 may include proprietary or third-party software adapted to be used in a particular application. In this example embodiment, the chatbot 48 is integrated within the chat platform 10 to leverage the recommendation engine 36 and machine learning engine 38 to intelligently infer, predict, or direct/re-direct the user of the client device 12 to a form, tool, page, tab, widget, or other graphical user interface portion that enables the user of the client device 12 to execute an action associated with a function, service, or tool of an application. The application can be a web-based application accessible through the client device 12 or an “app” residing on the client device 12, or any other platform or portal that effectively provides the same functionality, collectively referred to herein as an “application” having elements that require information to be added or entered to execute the action. It can be appreciated that the delineation between the access control module 44, app-chat integration module 46, and chatbot 48 as shown in FIG. 2 is for illustrative purposes. That is, these modules may also be integrated or otherwise provided via functions associated with a single module.

The platform 10 may also include a financial institution interface module 50 to provide a GUI or API connectivity to communicate with the financial institution system 16 to obtain financial data 68 for a certain user (see FIG. 3). It can be appreciated that the financial institution interface module 50 may also provide a web browser-based interface, an application or “app” interface, a machine language interface, etc.

In FIG. 3, an example configuration of the financial institution system 16 is shown. The financial institution system 16 includes a communications module 60 that enables the system 16 to communicate with one or more other components of the computing environment 8, such as client device 12 (or one of its components) or chat platform 10, via a bus or other communication network, such as the communication network 14, While not delineated in FIG, 3, the system 16 includes at least one memory or memory device that can include a tangible and non-transitory computer-readable medium having stored therein computer programs, sets of instructions, code, or data to be executed by one or more processors (not shown for clarity of illustration). HG. 3 illustrates examples of servers and datastores/databases operable within the system 16. It can be appreciated that any of the components shown in FIG. 3 may also be hosted externally and be available, to the system 16, e.g., via the communications module 60. In the example embodiment shown in FIG, 3, the financial institution system 16 includes one or more servers to provide access to financial data 68 to the chat platform 10 to enable the chat platform 10 to facilitate the execution of an action. Such actions can include coordinating with the financial institution platform 16 to facilitate or carry out a service requested by user via the client device 12 in conjunction with the chat platform 10. Exemplary servers include a mobile application server 62, a web server 66 and a data server 70. Although not shown in FIG .3, as noted above, the system 16 may also include a cryptographic server for performing cryptographic operations and providing cryptographic services. The cryptographic server can also be configured to communicate and operate with a cryptographic infrastructure. The system 16 may also include one or more data storages for storing and providing data for use in such services, such as data storage for storing financial data 68.

Mobile application server 62 supports interactions with a mobile application installed on client device 12. Mobile application server 62 can access other resources of the financial institution system 16 to carry out requests made by, and to provide content and data to, a mobile application on client device 12. In certain example embodiments, mobile application server 62 supports a mobile banking application to provide payments from one or more accounts of user, among other things. As shown in FIG. 3, the mobile application server 62 can include a chat API 64 which enables the mobile application to integrate or otherwise coordinate or work with the chat platform 10 to provide a conversational messaging type application, referred to herein as a chat user interface. For example, the chat API 64 can communicate with the chat platform 10 via the app-chat integration module 46 in the chat platform 10 (see FIG. 2). This allows, for example, the chatbot 48 (or a live human agent if applicable) to communicate with the client devices 12 via the chat user interface, whether that chat user interface is integrated within an application or an application in and of itself.

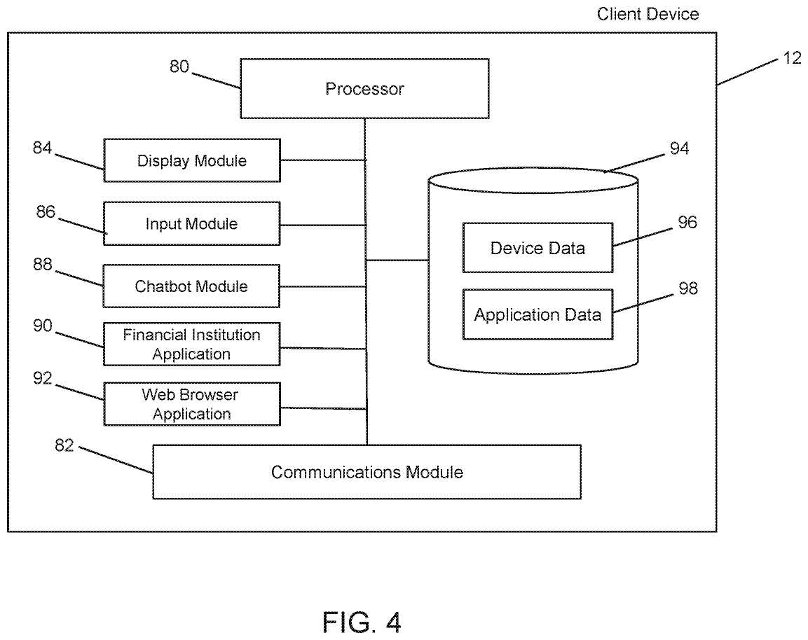

Web application server 66 supports interactions using a website accessed by a web browser application 92 (see FIG. 4) running on the client device 12. It can be appreciated that the mobile application server 62 and the web application server 66 can provide different front ends for the same application, that is, the mobile (app) and web (browser) versions of the same application. For example, the financial institution system 16 may provide a banking application that be accessed via a smartphone or tablet app while also being accessible via a browser on any browser-enabled device. As shown in FIG. 3, the web application server 66 may also include a chat API 64 to enable the web application to integrate or otherwise coordinate or work with the chat platform 10 to provide a conversational messaging type application.

The financial data 68 may be associated with users of the client devices 12 (e.g., customers of the financial institution). The financial data 18 may include any data related to or derived from financial values or metrics associated with customers of the financial institution system 16, for example, account balances, transaction histories, line of credit available, credit scores, mortgage balances, affordability metrics, investment account balances, investment values and types, among many others. Other metrics can be associated with the financial data 68, such as financial health data that is indicative of the financial health of the users of the client devices 12.

In FIG. 4, an example configuration of the client device 12 is shown. In certain embodiments, the client device 12 may include one or more processors 80. a communications module 82, and a data store 94 storing device data 96 and application data 98. Communications module 82 enables the client device 12 to communicate with one or more other components of the computing environment 8, such as platform 10 or financial institution system 16, via a bus or other communication network, such as the communication network 14. While not delineated in FIG. 4, the client device 12 includes at least one memory or memory device that can include a tangible and non-transitory computer-readable medium having stored therein computer programs, sets of instructions, code, or data to be executed by processor 80. FIG. 4 illustrates examples of modules and applications stored in memory on the client device 12 and operated by the processor 80. It can be appreciated that any of the modules and applications shown in FIG. 4 may also be hosted externally and be available to the client device 12, e.g., via the communications module 82.

In the example embodiment shown in FIG. 4, the client device 12 includes a display module 84 for rendering GUIs and other visual outputs on a display device such as a display screen, and an input module 86 for processing user or other inputs received at the client device 12, e.g., via a touchscreen, input button, transceiver, microphone, keyboard, etc, The client device 12 may also include a chatbot module 88, which may take the form of a customized app, plug-in, widget, or software component provided by the chat platform 10 for use by the client device 12 to engage in conversational messaging via a chat user interface. As indicated above, such a chat user interface can be a stand-alone application or be a page, tab or portion of another application such as a mobile banking application. The chat user interface may also be navigable to/from such an application, e,g., using the chatbot module 88, Similarly, the client device 12 may include a financial institution application 90 provided by their financial institution system 16, e.g., for performing mobile banking operations. The client device 12 in this example embodiment also includes a web browser application 92 for accessing Internet-based content, e.g., via a mobile or traditional website. The data store 94 may be used to store device data 96, such as, but not limited to, an IP address or a MAC address that uniquely identifies client device 12 within environment 8. The data store 94 may also be used to store application data 98, such as, but not limited to, login credentials, user preferences, cryptographic data (e.g., cryptographic keys), etc.

It will be appreciated that only certain modules, applications, tools and engines are shown in FIGS. 2 to 4 for ease of illustration and various other components would be provided and utilized by the chat platform 10, financial institution system 16, and client device 12, as is known in the art.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of any of the servers or other devices in platform 10 or financial institution system 16, or client device 12, or accessible or connectable thereto. Any application or module herein described may be implemented using computer readable/executable instructions that may be stored or otherwise held by such computer readable media.

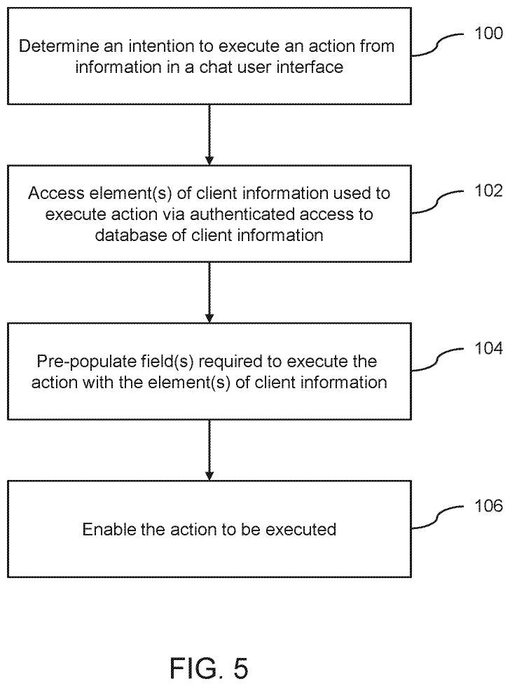

Referring to FIG. 5, an example embodiment of computer executable instructions for executing actions in applications using information determined from a chat user interface is shown. At block 100, the chat platform 10 (e.g., the chatbot 48) or an application in which or with which the chat platform 10 is being used (e.g., the financial institution application 90) determines from message and other content in a chat between a user and the chat platform 10 (e.g., between the user and the chatbot 48) an intention by the user to execute an action. For example, the user may ask a direct question such as “how do I transfer funds”. In another example scenario, the user may indirectly infer such an action, e.g., by suggesting that they have extra funds that could be saved.

Once one or more intended actions is/are determined at block 100, at block 102, the chat platform 10 may use authenticated access to information associated with the user, i.e., “client information” to obtain elements of such client information. The client information may include either or both chat data 18 (including, for example, client profile or other data related to the user or past chat histories, etc.) and financial data 68 (e.g., details of what accounts, balances, credit, etc. the user may have).

By obtaining such elements of client information, at block 104, the chat platform 10 can (or can have) fields in a form, tab, page, or other input-type user interface of an application that is associated with a particular action. For example, by accessing the client information exemplified above, a fund transfer page or form of a banking application can be opened and at least one of the fields pre-populated. For a fund transfer, the originating account, destination account, date, frequency, and amount may be able to be pre-populated based on the context of the conversation in which the chat platform 10 determined the intention to execute this action.

At block 106, the chatbot 48 or application can enable the action to be executed, e.g., by providing access to the pre-populated form or page with an option or other ability to confirm execution of the action.

It can be appreciated that the execution of the action and the integration and navigation between the chat user interface and the application which enables the action to be executed can be done in several ways. For example, the user can be navigated directly to an existing and familiar page within the application with the element(s) provided to the application for pre-populating certain fields. In another example, the chat user interface can be adapted to include a version of the page of the application within a chat message. Moreover, the manner in which the action to be executed is determined may vary as explained below. For example, an action can be requested by the user, or predicted or inferred and suggested by the chatbot 48.

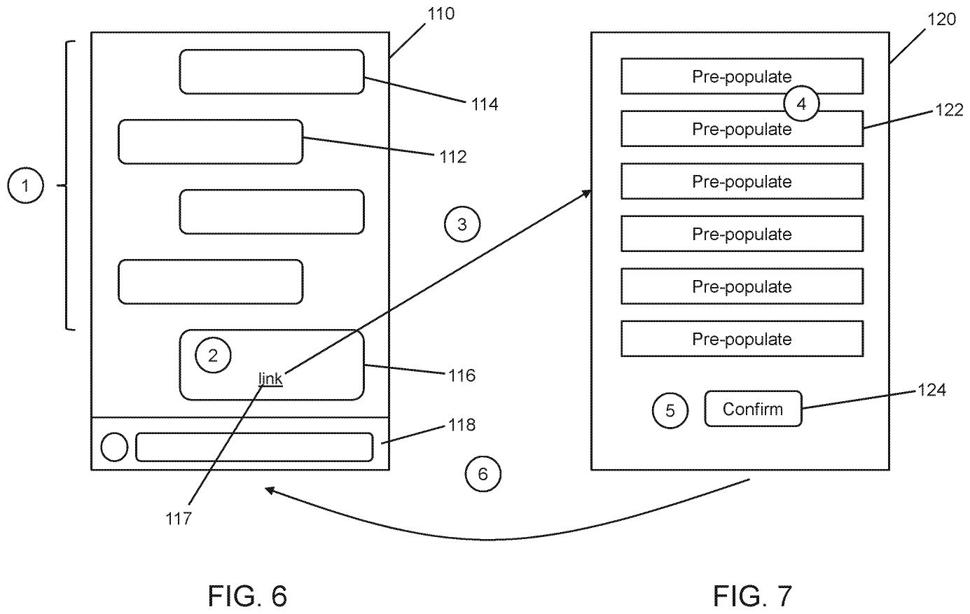

Referring to FIG. 6, an example of a graphical user interface (GUI) for a chat application, i.e., a chat user interface 110 is shown. The chat user interface 110 enables conversational style messaging between a plurality of parties. In this example, a user message 112 is displayed differently from a chatbot message 114 (or chat agent message) within the chat user interface 110 and messages can be sent by the user by interacting with a message composition tool 118. In stage 1 identified in FIG. 6, a series of messages are exchanged between the parties. For example, the user may ask questions concerning their account(s), how to use the app or website, or other general inquires. The chatbot 48 or any live agent that is responsible for conversing with the user may respond with answers to questions or provide information, content, or links to content or portions of the app or website. From these messages, the chat platform 10 can determine a context of the exchange to determine an intention to execute an action or may generate a prediction (that becomes a suggestion) dependent upon that context and the specificity of the content within the messages 112, 114. In stage 2, an action message 116 may be displayed by the chatbot 48 within the chat user interface 110. This allows the chatbot 48 to suggest, predict or otherwise follow up with the user in relation to an action that they desire or may desire to execute. In the example shown in FIG. 6, the action message 116 includes a link 117 that is selectable in the chat user interface 110 by the user.

The link 117, when selected, initiates a navigation at stage 3 to an application user interface 120, shown in FIG. 7, which is associated with the action. The link 117 may direct the user to a certain form, page or tab within the application user interface 120, which form, page or tab is used to complete at least a portion of the action. In stage 4, the chat platform 10 or the financial institution system 16 (or other entity responsible for implementing features of the application associated with the application user interface 120) pre-populates at least one field 122 in the application user interface 120 that are used to execute at least part of the action. The field(s) 122 is/are pre-populated by inserting or selecting content (e.g., from a pull-down menu, radio buttons, check boxes, etc.) based on the functionality of that particular field 122. The content to be inserted or the option to be selected can be determined from the context of the messages 112, 114 exchanged between the parties and/or from other client information that is obtained from another source, in this example from the financial data 68 held by the financial institution system 16. In either case, the chat platform 10 has authenticated access to such client information. The authenticated access may be obtained previously through a login, by sharing or providing a token, or through some cryptographic measure applied within the particular application or environment. That is, the chat platform 10 may leverage both context information determined from the chat and information specific to the client in order to determine, infer, predict or suggest an action to be executed. Moreover, the chat platform 10 is configured to enable the action to be executed by navigating or otherwise providing a form, page, tab or other user interface portion for the application that is configured to execute the action. In stage 5, the application user interface 120 in this example provides a Confirm button 124 to enable the user to confirm the contents of the fields 122 prior to proceeding with initiating execution of the action or proceeding to a next stage in providing the information necessary to complete the action. It can be appreciated that the fields 122 can be provided in an editable form, such as in a native format and look that is familiar to the user, and which provides the ability for the user to change an incorrect value or make a different selection. For example, the chat platform 10 may use the app-chat integration module 46 to perform the pre-population of existing fields normally provided by the application user interface 120. In the example above concerning a transfer of funds using a financial institution application 90 (e.g., mobile banking), this would include navigating the user to the financial institution application 90 on their client device 12. It can be appreciated that the chat platform 10 can be configured to bypass certain steps within the financial institution application 90 to go directly to the application user interface 120, e.g., to open the application 90 with the appropriate page, tab, or form displayed to the user.

It may be noted that FIGS. 6 and 7 illustrate separate chat and application user interfaces 110, 120, and such user interfaces 110, 120 may be displayed one at a time, e.g., on a relatively small smartphone screen, or may be displayed together at the same time, e.g., side-by-side on a larger tablet or PC screen, or on a dual-screen smartphone. Moreover, as noted above, the chat platform 10 may be integrated with the application associated with the user interface 120 to various degrees and thus the chat user interface 110 may be provided as a page or tab directly within the application user interface 120 or may be provided as a standalone application.

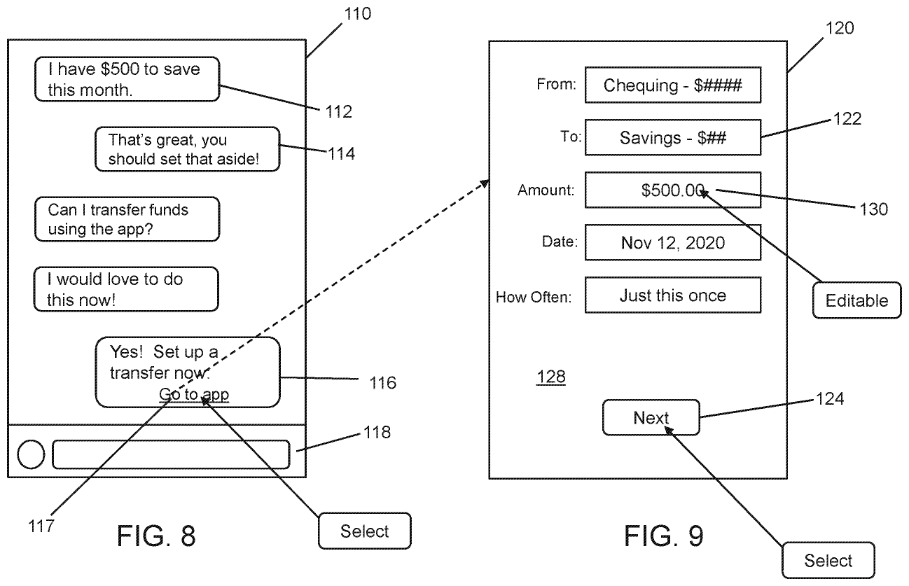

FIGS. 8 and 9 illustrate an example of the principles shown in FIGS. 6 and 7 wherein the application user interface 120 is associated with the financial institution application 90 and the action relates to a financial transaction. As shown in FIG. 8, in this example, the user messages 112 include an indication of a value ($500) and an intention to transfer these funds and that they are intending to do this now. The chat platform 10 can therefore, in this example, determine that a funds transfer page 128 (shown in FIG. 9) within the financial institution application 90 is the appropriate application user interface 120 for executing the intended action. Turning now to FIG. 9, the funds transfer page 128 includes a number of fields 122 that identify the source account (from) and target account (to), as well as the amount, date, and frequency of the transfer. From the context of the conversation shown in FIG. 8, it is determined that the user wishes to transfer $500 and this field 122 can be pre-populated with an editable value 130. It may be noted that in this example, the user did not specify from which account to transfer the funds, nor to which account the transfer should go. However, by having access to the financial data 68, the chat platform 10 determines that the user has only a chequing account (with a suitable balance permitting the transfer) and a single savings account. The chat platform 10 also assumes the same date as the conversation in the chat user interface 110 for the transfer and assumes that this is a single transfer (as opposed to a monthly or other periodic transfer). These fields 122 can be edited and manipulated by the user and a Next button 124 may then be selected to proceed with the transfer per the information in the fields 122.

It can be appreciated that the chat platform 10 and/or associated application (e.g., financial institution application 90) can be configured to detect and flag incompatibilities with the action, particularly if the action is being requested by the user (rather than being suggested by the chatbot 48). For example, the user may have erred in specifying how much they are able to transfer and may only have $400 available due to pending transactions. The application user interface 120 can be altered or instructed to flag these incompatibilities, or the chat platform 10 can have a prompt or window displayed to notify the user. That is, the incompatibility can be dealt with in various ways to enable the user to correct the incompatibility or return to the chat user interface 110 to determine how to correct the incompatibility. For example, if the user does not yet have a savings account, a prompt can be displayed (not shown) directing the user back to the chat user interface 90 and then the chat platform 10 can provide another action message 116 that links to a form to open a new savings account. The user may also message the chatbot 48 to provide a new intent, for example, to have the additional funds transferred to a registered retirement savings account, a tax-free savings account, or to be used as a bill payment or to go against a balance in a line of credit.

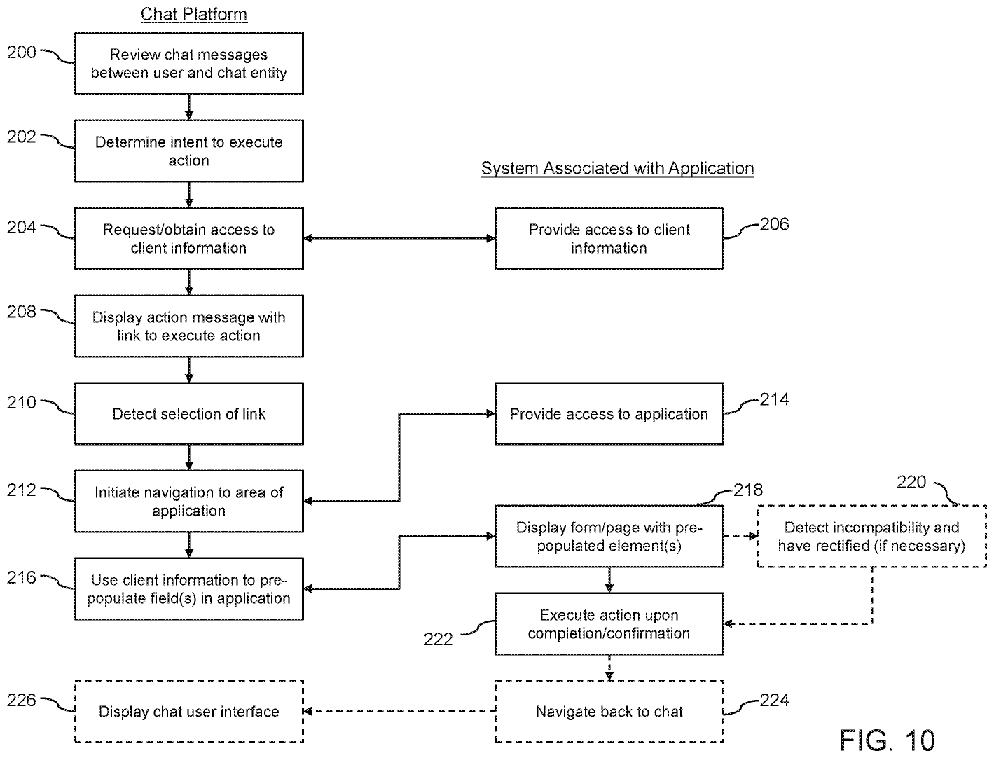

FIG. 10 is a flow diagram of an example of computer executable instructions for executing an action in an application by navigating to that application and interacting with another system that is associated with the application. At block 200, the chat platform 10 reviews or otherwise examines or analyzes the contents of the chat messages 112, 114 between the user and the chat entity, for example, the chatbot 48 and/or a live agent. At block 202, the chat platform 10 determines from the content of the messages 112, 114 an intent to execute an action. For example, the chat platform 10 can utilize the recommendation engine 36 to infer or otherwise identify this intention. The chat platform 10 can then, at block 204, request or obtain access to client information. As noted above, this may include accessing the chat data 18 as well as data that is stored by the system associated with the application. In the example shown herein, that would include requesting or obtaining access to the financial data 68 from the financial institution system 16. The system thus provides access to at least some of the client information at block 206.

At block 208, the chat platform 10 displays an action message 116 (see FIGS. 6 and 8) with a link 117 to enable the user to initiate navigation to an area of the application user interface 120. At block 210 the chat platform detects selection of the link 117 and this initiates navigation to the area of the application user interface 120 at block 212. The system associated with the application and the application user interface 120 provides access to the application at block 214. The chat platform 10 also then uses the client information along with any contextual information it has determined from the messages 112, 114 to pre-populate one or more fields 122 in the application user interface 120 at block 216. In this example, the system associated with the application user interface 120 displays a form, tab, or page with the pre-populated elements at block 218. As illustrated in dashed lines, when an incompatibility is detected, the system (or chat platform 10) may detect the incompatibility and have it rectified as noted above at block 220. The action is executed upon a completion or confirmation of the area of the application user interface 120 being interacted with, at block 222. As also shown in dashed lines in FIG. 10, the application user interface 120 may provide a prompt or other option for the user to navigate back to the chat user interface 110 at block 224 which, when selected, would cause the client device 12 to display the chat user interface 110 again at block 226.

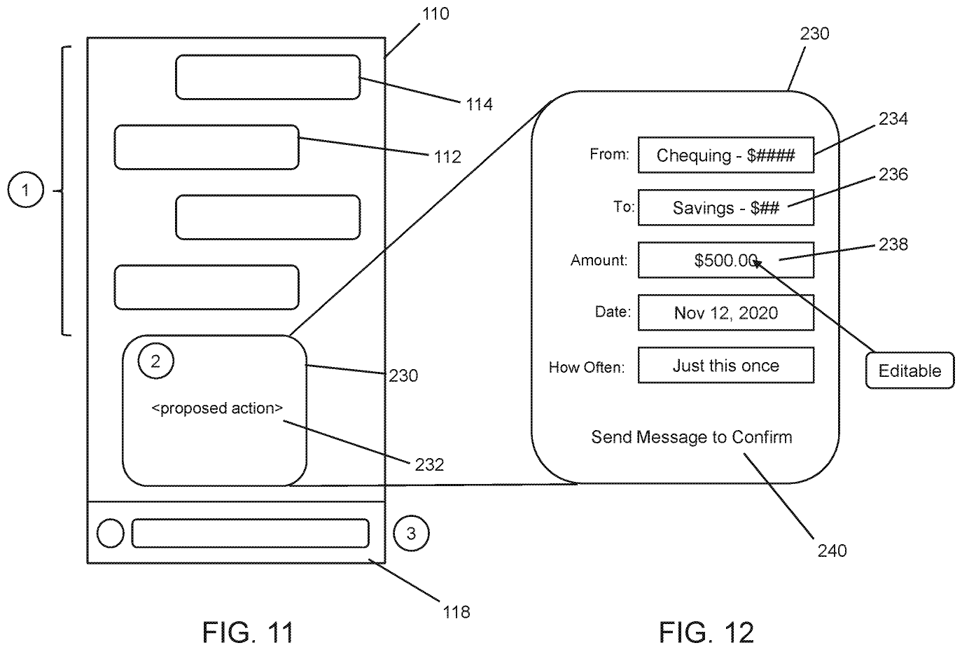

Turning now to FIGS. 11 and 12, an example embodiment is shown in which the chat user interface 110 integrates the functionality of the form, tab or page of the application user interface 120 into an action execution message 230 that contains elements and content for a proposed action 232 that can be interacted via the message 230. As shown in FIG. 11, an action execution message 230 may be displayed instead of an action message 116 containing a link 117. In this way, the action can be determined, initiated, completed and confirmed all from within the chat user interface 110, by further leveraging the integration between the chat platform 10 and the system associated with the application (e.g., the financial institution system 16).

The scenario depicted in FIGS. 11 and 12 may be used to provide a deeper integration between the chat user interface 110 and the application user interface 120. However, in some example embodiments, the navigation to/from the existing and familiar application user interface 120 shown in FIG. 7 may be preferred by certain users or for regulatory or other constraints. It may be noted that if both scenarios are permitted in the context of executing the type of action requested, a predetermined user preference or user confirmation could be used to allow the user to have a choice between these scenarios. For example, for some types of action such as fund transfers, the user may wish to quickly execute the action from within the chat user interface 110 while for other more complex actions such as applying for a new financial product, the user may prefer to navigate to within the application user interface 120.

FIG. 12 is an enlarged view of the action execution message 230 from FIG. 11 in which the same fields 122 are pre-populated as with FIG. 9. In this example, confirmation of the action can be made by sending the message via the message composition tool 118 in the chat user interface 110. That is, the action execution message 230 can be a pre-populated user message 112 that is editable and capable of being sent by the user to confirm its contents. It can be appreciated that other mechanisms can be used to implement the action execution message 230. For example, the action execution message 230 can be a pre-populated and editable chatbot message 114 to which a reply is required to confirm the contents presented to the user by the chatbot 48.

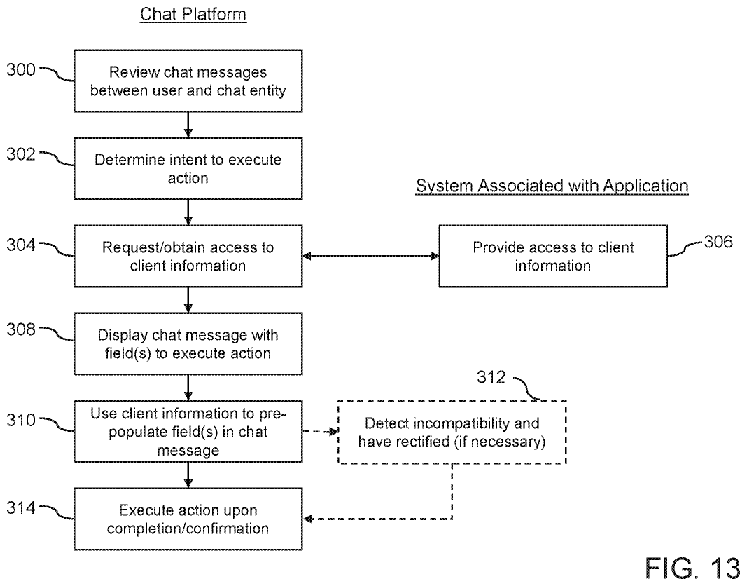

Turning now to FIG. 13, an example of computer executable instructions for executing an action within a chat user interface 110 is shown. At block 300, the chat platform 10 reviews or otherwise examines or analyzes the contents of the chat messages 112, 114 between the user and the chat entity, for example, the chatbot 48 and/or a live agent. At block 302, the chat platform 10 determines from the content of the messages 112, 114 an intent to execute an action. For example, the chat platform 10 can utilize the recommendation engine 36 to infer or otherwise identify this intention. The chat platform 10 can then, at block 304, request or obtain access to client information. As noted above, this may include accessing the chat data 18 as well as data that is stored by the system associated with the application. In the example shown herein, that would include requesting or obtaining access to the financial data 68 from the financial institution system 16. The system thus provides access to at least some of the client information at block 306.

At block 308, the chat platform 10 displays an action execution message 230 (see FIGS. 11 and 12) with fields and content to enable the action to be executed by interacting with that message 230. At block 310 the chat platform 10 uses the client information along with any contextual information it has determined from the messages 112, 114 to pre-populate one or more fields 122 in the execution message 230. As illustrated in dashed lines, when an incompatibility is detected, the system (or chat platform 10) may detect the incompatibility and have it rectified as noted above at block 312. The action is executed upon a completion or confirmation at block 314. For example, as shown in FIG. 12, sending the action execution message 230 can be performed to confirm the contents of the pre-populated and editable content.

Turning now to FIG. 14, the chat platform 10 may also be capable of using the recommendation engine 36 to predict an action based on the conversational exchange between a user and the chatbot 48 or live agent. At block 400 the chat platform 10 reviews or otherwise examines or analyzes the contents of the chat messages 112, 114 between the user and the chat entity, for example, the chatbot 48 and/or a live agent. At block 402, the chat platform 10 determines an action to propose to the user. For example, the chat platform 10 may determine that the user has additional funds that they want to do something with and could suggest a transfer to their savings account based on knowledge of the accounts held by that user. At block 404, the chat platform 10 may display a message with the proposed action and with an ability to initiate execution of the action. In this way, the user can accept the suggestion or continue the conversation to be more specific and potentially lead to a more direct exchange such as that described above. At step 406, if confirmed, the user can be navigated to the application user interface 120 (e.g., per FIG. 7) or an action execution message 320 can be displayed (e.g., per FIG. 9) and operations performed as at block 204 or 304 respectively.

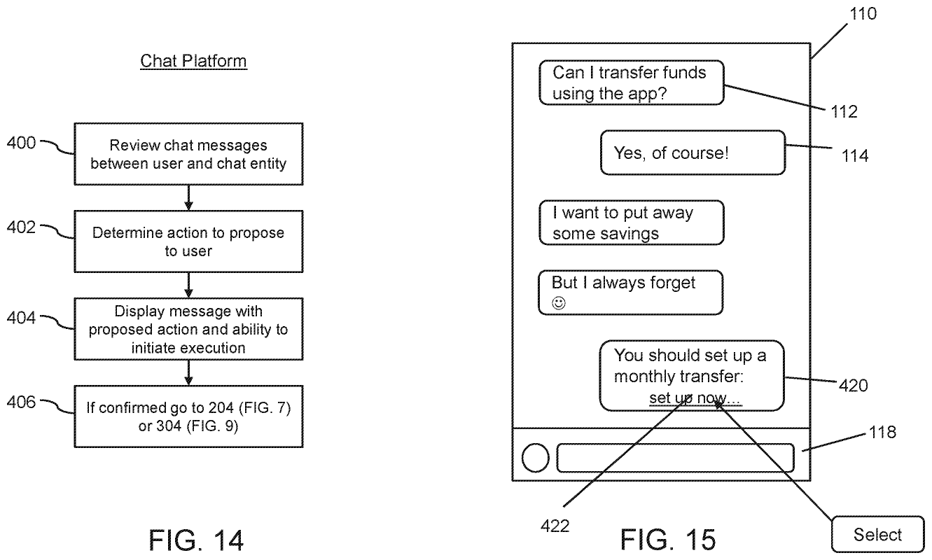

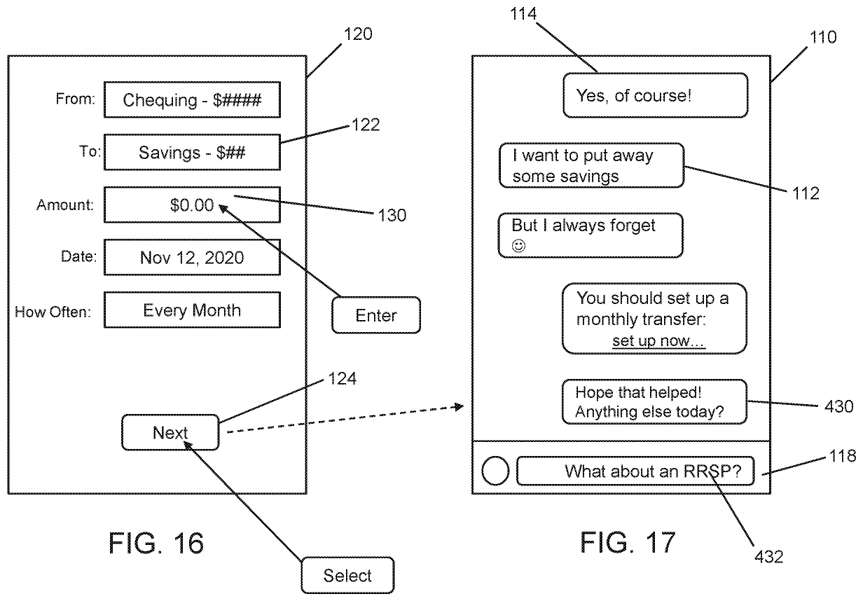

FIGS. 15 to 17 are screen shots of the chat user interface 110 and application user interface 120 for a predicted action determined by the chat platform 10. Turning first to FIG. 15, in this example conversational exchange, the user is inquiring about transferring funds but also alludes to having surplus funds periodically. In this case, the chat platform 10 generates a prediction, using the recommendation engine 36, that the user may wish to set up a monthly transfer of their surplus funds. A predicted action message 420 is displayed by the chatbot 48 in this example and provides a predicted action link 422 to enable the user to accept the predicted/suggested action. As noted above, if the suggested action is not desirable, the user may continue to use the message composition tool 118 to continue the discussion and arrive at a different action. For example, the user could reply that they just want to set up a transfer for now (as opposed to monthly) by way of a return user message 112 (not shown). Continuing with this example, the user selects the predicted action link 422 which navigates from the chat user interface 110 to the application user interface 120 as shown in FIG. 16.

It can be appreciated that the application user interface 120 shown in FIG. 16 is similar to the examples provided about but does not include an amount but enables the user to enter an amount. This is because the conversational exchange did not provide a specific value. The application user interface 120 in this example also pre-populates the “How Often” field 122 with “Every Month” since the predicted action corresponds to a monthly transfer. The user could change this, for example, if they wanted to enter a lower amount or a higher frequency such as every two weeks.

By selecting the Next button 124, in this example, the user is navigated back to the chat user interface 110 as shown in FIG. 17 and the chatbot 48 can use the opportunity to follow up with the user by sending a follow up message 430. In this example, the chatbot 48 asks whether the user wants to do anything else. This also provides an opportunity to perform follow up actions. The user in this example begins composing a follow up message 432: “What about an RRSP?” using the message composition tool 118. This may lead to additional messages to obtain context. The chat platform 10 can also use access to the financial data 68 to determine if the user already has an RRSP account and then respond accordingly, e.g., asking whether the user wants to do an additional monthly transfer into that account.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A device for identifying and executing actions from chat user interfaces, the device comprising:
a processor;
a communications module coupled to the processor; and
a memory coupled to the processor, the memory storing computer executable instructions that when executed by the processor cause the processor to:
determine an intention to execute an action, from information in a chat conversation between a client device and an entity in a chat user interface;
access via the communications module at least one element of client information required to execute the action, the at least one element of client information being accessible by the device using authenticated access to a database of client information;
pre-populate at least one field required to execute the action using the at least one element of client information; and
enable the action to be executed.

2. The device of claim 1, wherein the computer executable instructions further cause the processor to:
display via the client device an application for executing the action, the application comprising a plurality of fields required to execute the action, including the at least one pre-populated field.

3. The device of claim 2, wherein the computer executable instructions further cause the processor to:
enable navigation back to the chat user interface after executing the action.

4. The device of claim 2, wherein the chat user interface and application are displayed side-by-side on a display of the client device.

5. The device of claim 1, wherein the computer executable instructions further cause the processor to:
display via the client device a plurality of fields required to execute the action, including the at least one pre-populated field, with a message in the chat user interface.

6. The device of claim 1, wherein the action is associated with a financial transaction requiring a form to be populated.

7. The device of claim 1, wherein the intention to execute the action is determined from at least one question added to the conversation by the client device.

8. The device of claim 1, wherein the intention to execute the action is predicted based on content from at least one message in the conversation.

9. The device of claim 8, wherein the computer executable instructions further cause the processor to:
suggest a predicted action; and
have the client device confirm the predicted action.

10. The device of claim 1, wherein the computer executable instructions further cause the processor to:
suggest a periodic action to be executed on a periodic basis subsequent to the action being executed;
have the client device confirm the periodic action; and
arrange the periodic action for an application used by the client device.

11. The device of claim 1, wherein the computer executable instructions further cause the processor to:
determine an incompatible one of a plurality of elements of client information;
indicate via the client device an incompatibility in a corresponding pre-populated field; and
determine that the incompatibility has been rectified prior to enabling the action to be executed.

12. The device of claim 11, wherein the incompatibility is indicative of a value that is incompatible with the action to be executed.

13. The device of claim 12, wherein the value is associated with a financial transaction.

14. A method of identifying and executing actions from chat user interfaces, the method executed by a device having a communications module and comprising:
determining an intention to execute an action, from information in a chat conversation between a client device and an entity in a chat user interface;
accessing, via the communications module, at least one element of client information required to execute the action, the at least one element of client information being accessible by the device using authenticated access to a database of client information;
pre-populating at least one field required to execute the action using the at least one element of client information; and
enabling the action to be executed.

15. The method of claim 14, further comprising:
displaying, via the client device, an application for executing the action, the application comprising a plurality of fields required to execute the action, including the at least one pre-populated field.

16. The method of claim 14, further comprising:
displaying, via the client device, a plurality of fields required to execute the action, including the at least one pre-populated field, with a message in the chat user interface.

17. The method of claim 14, wherein the intention to execute the action is predicted based on content from at least one message in the conversation, and further comprising:
suggesting a predicted action; and
having the client device confirm the predicted action.

18. The method of claim 14, further comprising:
suggesting a periodic action to be executed on a periodic basis subsequent to the action being executed;
having the client device confirm the periodic action; and
arranging the periodic action for an application used by the client device.

19. The method of claim 14, further comprising:
determining an incompatible one of a plurality of elements of client information;
indicating, via the client device, an incompatibility in a corresponding pre-populated field; and
determining that the incompatibility has been rectified prior to enabling the action to be executed.

20. A non-transitory computer readable medium for identifying and executing actions from chat user interfaces, the computer readable medium comprising computer executable instructions for:
determining an intention to execute an action, from information in a chat conversation between a client device and an entity in a chat user interface;
accessing, via a communications module, at least one element of client information required to execute the action, the at least one element of client information being accessible by the device using authenticated access to a database of client information;
pre-populating at least one field required to execute the action using the at least one element of client information; and
enabling the action to be executed.
